(19) United States
(12) Patent Application Publication
(10) Pub. No.: US 2003/0163453 A1
(43) Pub. Date: Aug. 28, 2003

(54) Method of narrow search for books the internet

(75) Inventors: Sung Woo Yang, Los Angeles, CA (US); Chang Ho Chung, (US)

Correspondence Address: CHARLES C.H. WU, ESQ., CHARLES C.H. WU & ASSOCIATES, APC, 7700 IRVINE CENTER DRIVE, SUITE 710, IRVINE, CA, 92618, US

(73) Assignee: TECHNO MECCA, INC.

(21) Appl. No.: 10/082,188

(22) Filed: Feb. 26, 2002

(51) Int. Cl. G06F 7/00

(52) U.S. Cl. 707/3

(57) ABSTRACT

A method of narrow search for books on the Internet is disclosed. In response to a search term entered by a customer, a vendor's database is searched. The result of the search is stored in a narrow database. The customer may enter another narrow search term to further narrow down the search. In response to the narrow search term entered by the customer, the vendor's narrow database is searched. The result of the search is stored in the narrow database. The customer may again enter another narrow search term to further narrow down the search. The process is repeated until either the narrow database is exhausted or a desired book is located.

### FIELD OF THE INVENTION

The present invention relates to a method of narrow search for books on the Internet.

### BACKGROUND OF THE INVENTION

With the advent of the Internet, more and more consumers are purchasing merchandise on line. This is especially true in the area of book sales. A growing number of companies offer the convenience of searching their on line databases containing thousands of book titles. Such search can be done by a variety of search terms, such as book title, author, subject, ISBN (an International Standard Book Number—a unique number assigned to every book published in the world that is normally printed on a book cover as a bar code), and many others. Upon finding the desired book, a customer would have an option of ordering and paying for the book on line.

However, despite the ease of searching and ordering books via the Internet, searching by a key word normally yields too many results. This requires online shoppers to wade through numerous search results without being able to further narrow down the search. For example, in any online booksellers' key word search, the search by the key word “marketing” will yield more than 3,000 titles. From this point, an average search system will not allow customers to narrow down the search. They have to start a new search by using a more refined key word or combination of words.

Accordingly, there is a clear need for a method that would allow to narrow down the search results within the search and without starting a new search.

### SUMMARY OF THE INVENTION

The present invention is directed to a method of narrow search for books on the Internet. A book vendor stores book identifying information (such as book title, author, subject, ISBN) in a main database on its server system. A customer enters a search term in the vendor's web page accessible to the customer via the Internet. In response to the search term entered by the customer, the main database is searched to match the search term with the book identifying information and retrieve a search result comprising the book identifying information matching the search term. The search result is then stored in a narrow database and displayed in the vendor's web page.

In response to the narrow search term entered by the customer, the narrow database is accessed to match the narrow search term with the book identifying information and retrieve a narrow search result comprising the book identifying information matching the narrow search term. The narrow search result is again stored, in the narrow database in the vendor server system.

The customer can view the narrow search result and then again enter a narrow search term in order to even further narrow down the search. These steps can be repeated until either the narrow database is exhausted or a desired book is located.

### BRIEF DESCRIPTION OF THE DRAWING FIGURES

FIG. 1 through FIG. 5 depict web pages viewed by a customer employing a narrow search for books on the Internet according to the method of this invention.

### DETAILED DESCRIPTION OF THE PREFERRED EMBODIMENT

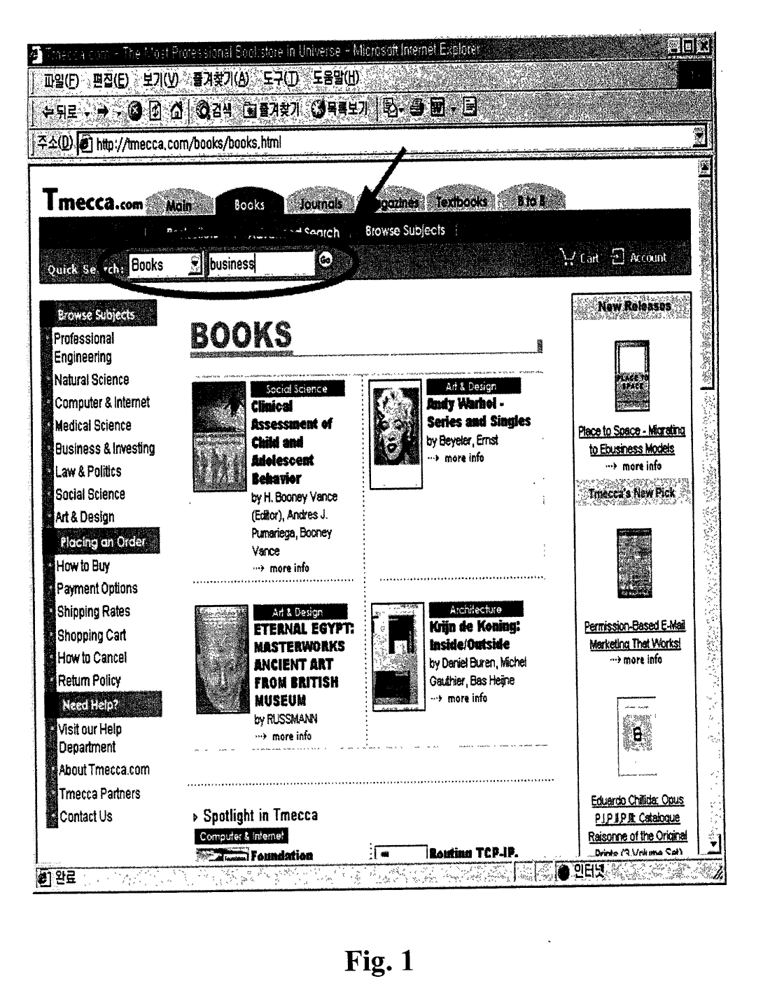

The present invention will be better understood with reference to FIG. 1 through FIG. 5 depicting web pages viewed by a customer employing a narrow search for books on the Internet according to the method of this invention.

Viewing FIG. 1, there is shown the web page viewed by a customer initiating a search according to the method of this invention. Viewing the top portion of FIG. 1, there is shown a means for entering a search term indicated by an arrow. Means for entering a search term allows the customer to enter a search term and then communicate the search to the vendor's server system. In the example shown in FIG. 1, there is a window for typing in the search term and a “Go” button that the customer would click to initiate the search. For the sake of an example, the customer enters the search term “business” In response to the search term “business” entered by the customer, the main database is searched to match the search term “business” with the previously stored book identifying information and retrieve a search result comprising the book identifying information matching the search term “business”. The book identifying information can include book title, author, subject, ISBN. The search result is then stored in a narrow database and displayed in the vendor's web page.

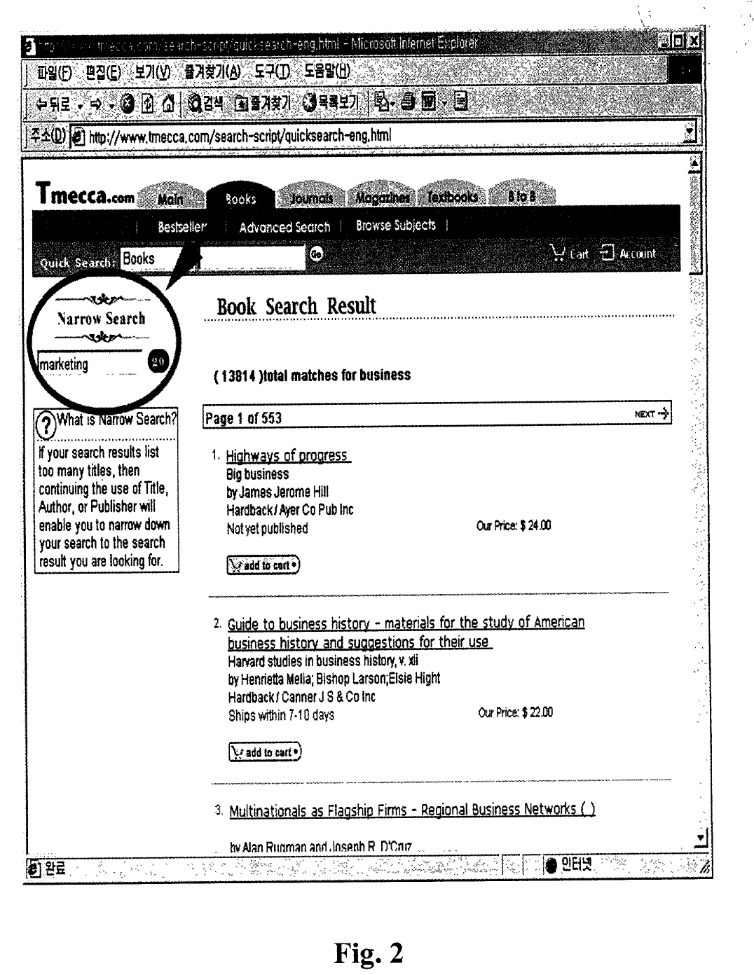

Viewing FIG. 2, there is shown the web page viewed by the customer with the book search result as follows: “(13814) total matches for business”. There is also shown means for entering a narrow search term in the left portion of FIG. 2. At this point, the customer can further narrow the search by entering a narrow search term in the means for entering a narrow search term. For the sake of an example, the customer enters the search term “marketing”. In response to the narrow search term “marketing” entered by the customer, the narrow database is accessed to match the narrow search term “marketing” with the book identifying information and retrieve a narrow search result comprising the book identifying information matching the narrow search term “marketing”. The narrow search result is again stored, in the narrow database in the vendor server system.

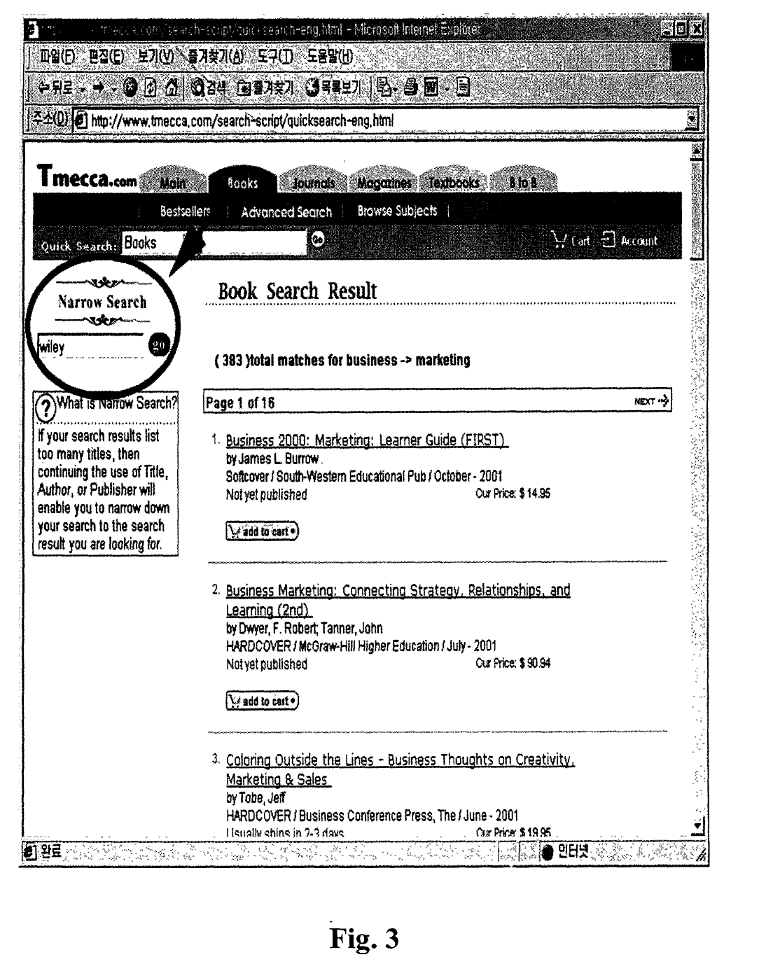

Viewing FIG. 3, there is shown the web page viewed by the customer with the book search result as follows: “(383) total matches for business→marketing”. The matches are displayed below. There is also shown means for entering a narrow search term in the left portion of FIG. 3. At this point, the customer can once again narrow down the search by entering a narrow search term in the means for entering a narrow search term. For the sake of an example, the customer enters the search term “wiley”. In response to the narrow search term “wiley” entered by the customer, the narrow database is accessed to match the narrow search term “wiley” with the book identifying information and retrieve a narrow search result comprising the book identifying information matching the narrow search term “wiley”. The narrow search result is again stored, in the narrow database in the vendor server system.

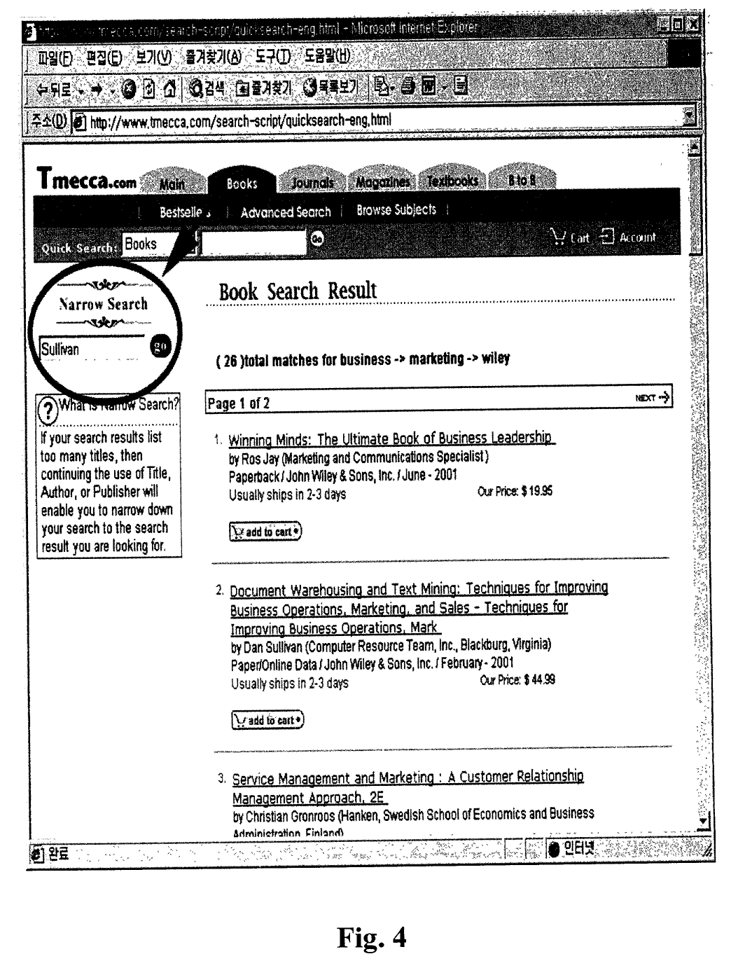

Viewing FIG. 4, there is shown the web page viewed by the customer with the book search result as follows: “(26) total matches for business→marketing→wiley”. The matches are displayed below. There is also shown means for entering a narrow search term in the left portion of FIG. 4. At this point, the customer can once again narrow down the search by entering a narrow search term in the means for entering a narrow search term. For the sake of an example, the customer enters the search term “Sullivan”. In response to the narrow search term “Sullivan” entered by the customer, the narrow database is accessed to match the narrow search term “Sullivan” with the book identifying information and retrieve a narrow search result comprising the book identifying information matching the narrow search term “Sullivan”. The narrow search result is again stored, in the narrow database in the vendor server system.

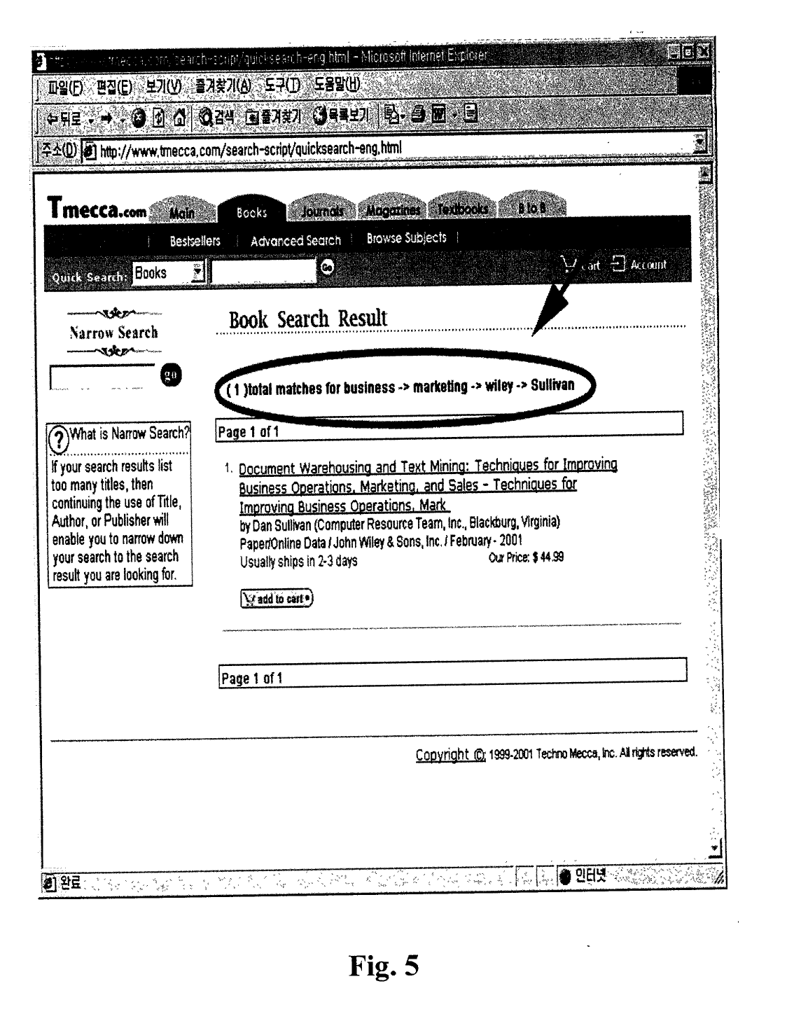

Viewing FIG. 5, there is shown the web page viewed by the customer with the book search result as follows: “(1) total matches for business→marketing→wiley→Sullivan”. The exact match is displayed below.

As can be seen, the customer was able to find one book out of many thousand books by employing the narrow search method of this invention.

The scope of the present invention is defined by the claims that follow.

What is claimed is:

1. A method of narrow search for books on the Internet comprising the steps of:
(a) under control of a vendor server system, storing book identifying information in a main database;
(b) under control of a customer system, displaying means for entering a search term;
(c) under control of the vendor server system, in response to the search term entered by the customer in the means for entering a search term, accessing the main database to match the search term with the book identifying information and retrieve a search result comprising the book identifying information matching the search term;
(d) under control of the vendor server system, storing the search result in a narrow database;
(e) under control of a customer system, displaying the search result and means for entering a narrow search term;
(f) under control of the vendor server system, in response to the narrow search term entered by the customer in the means for entering a narrow search term, accessing the narrow database to match the narrow search term with the book identifying information and retrieve a narrow search result comprising the book identifying information matching the narrow search term;
(g) under control of the vendor server system, storing the narrow search result in the narrow database;
(h) under control of a customer system, displaying the narrow search result and means for entering a narrow search term;
(i) repeating steps (f), (g) and (h) until either the narrow database is exhausted or a desired book is located.

2. A method as in claim 1, wherein said book identifying information further comprises an international standard book number.

3. A method as in claim 1, wherein said book identifying information further comprises a title.

4. A method as in claim 1, wherein said book identifying information further comprises an author.

5. A method as in claim 1, wherein said book identifying information further comprises a subject.
